(19) United States
(12) Patent Application Publication
(10) Pub. No.: US 2022/0193462 A1
(43) Pub. Date: Jun. 23, 2022

(54) Face Mask With Improved Air Flow

(71) Applicant: Spiritus Bio Inc., Orinda, CA (US)

(72) Inventors: Eugene A. Mizusawa, Castro Valley, CA (US); M. Allen Northrup, Orinda, CA (US); Philip E. Alei, Carlsbad, CA (US)

(21) Appl. No.: 17/545,877

(22) Filed: Dec. 8, 2021

Related U.S. Application Data
(60) Provisional application No. 63/130,173, filed on Dec. 23, 2020.

(51) Int. Cl. A62B 7/02; A41D 13/11; A62B 18/02; A62B 18/10; A62B 9/06

(52) U.S. Cl. CPC A62B 7/02; A41D 13/1107; A62B 9/06; A62B 18/10; A62B 18/025

(57) ABSTRACT

Provided herein are face masks, systems, and methods for using the face masks and systems. The face masks disclosed herein include a dome-shaped structure sized to cover a user's nose and mouth. The face masks include an inlet for passage of a tubing and a septum that divides the face mask into a nose chamber and a mouth chamber. The septum may include an opening or a gate. The gate may be configured to open downwards in response to exhalation from the nose of the user and to stay closed in absence of exhalation. The face mask may also include a filter located in the dome-shaped structure in an area adjacent to the mouth. The face mask may also include a filter located in the gate. The filter is configured to capture microscopic particles and nanoparticles. The systems provided herein may include a face mask as provided herein, an air pump comprising a filter, a tubing for delivering air from the air pump to the face mask. Alternatively, the face mask may be a nose mask that only covers the nose.

### INTRODUCTION

Covering airway openings such as nostrils and mouth has been shown to reduce transmission of pathogens. For example, wearing a mask covering nose and mouth has been shown to reduce spread of the severe acute respiratory syndrome coronavirus 2 (SARS-CoV-2 virus).

However, the currently available masks have several disadvantages, such as, accumulation of stale air rich in carbon dioxide, moisture, odors, and the like inside the mask. Thus, there is a need for alternate ways to reduce transmission of pathogens while improving comfort and wellbeing of mask users.

### SUMMARY

Provided herein are face masks, systems, and methods for using the face masks and systems. The face masks disclosed herein include a dome-shaped structure sized to cover a user's nose and mouth. The face masks include an inlet for passage of a tubing and a septum that divides the face mask into a nose chamber and a mouth chamber. The septum may include an opening or a gate. The gate may be configured to open downwards in response to exhalation from the nose of the user and to stay closed in absence of exhalation. The face mask may also include a filter located in the dome-shaped structure in an area adjacent to the mouth. The face mask may also include a filter located in the gate. The filter is configured to capture microscopic particles and nanoparticles. The systems provided herein may include a face mask as provided herein, an air pump comprising a filter, a tubing for delivering air from the air pump to the face mask. Alternatively, the face mask may be a nose mask that only covers the nose.

### BRIEF DESCRIPTION OF THE DRAWINGS

FIG. 1 depicts a system comprising a nose mask, tubing, and air pump according to an embodiment provided herein. A standard face mask can be used in conjunction with the nose mask.

FIG. 2 depicts another embodiment of a nose mask.

FIG. 3 provides a sideview of a facemask according to an embodiment provided herein.

FIGS. 4A-4E show a face mask with different configurations of the filter.

FIG. 5 shows a nose mask that can be converted into a face mask by attaching a detachable mouth chamber to the nose mask.

FIGS. 6-15 depict an auxiliary kit comprising a tubing connectable to an air pump and a face mask for delivering filtered air adjacent the nose of a person wearing a face mask.

### DETAILED DESCRIPTION

Provided herein are face masks, systems, and methods for using the face masks and systems. The face masks disclosed herein include a dome-shaped structure sized to cover a user's nose and mouth. The face masks include an inlet for passage of a tubing and a septum that divides the face mask into a nose chamber and a mouth chamber. The septum may include an opening or a gate. The gate may be configured to open downwards in response to exhalation from the nose of the user and to stay closed in absence of exhalation. The face mask may also include a filter located in the dome-shaped structure in an area adjacent to the mouth. The face mask may also include a filter located in the gate. The filter is configured to capture microscopic particles and nanoparticles. The systems provided herein may include a face mask as provided herein, an air pump comprising a filter, a tubing for delivering air from the air pump to the face mask. Alternatively, the face mask may be a nose mask that only covers the nose. Each of these masks, systems, and methods are described in detail in the sections that follow.

Before the present invention is further described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Face Masks

Provided herein are face masks that cover both nose and mouth of a user or just the nose of a user. A face mask that only covers the nose of a user is referred to herein as a nose mask. These face masks are reusable. By reusable, it is meant that the face mask can be used several times, and in some cases, indefinitely. These face masks are made from a plastic material to facilitate cleaning prior to reuse. Cleaning may involve wiping the mask with a wet cloth or wipe and/or washing the mask using a detergent.

In certain embodiments, the face mask is dome-shaped. By dome-shaped, it is meant that the mask is tented and rises from the periphery of the mask to a high point. The tented portion of the mask may have any shape such as hemispherical, pyramidal, frusto-spherical, frusto-conical, or an irregular three-dimensional shape. The length of the periphery and the height of the face mask may be varied. For example, the length of the periphery and the height of the face mask may in increased or decreased to fit faces of different users. In some embodiments, the face masks may have three standard sizes large, medium and small, where the small size may be suitable for children. In some embodiments, the face mask may be custom-made by for example, 3D printing to provide superior conformability to a user's face. In certain embodiments, the periphery of the dace mask may have an oval shape, circular shape, rhombus or diamond shape or an irregular shape. In some embodiments, the clearance between an inner surface of the mask and nostrils of a user may be at least 0.5 cm. For example, the clearance may be 0.5 cm to 5 cm, e.g., 1 cm-3 cm. In some embodiments, the clearance between an inner surface of the mask and lips of a user may be 0.5 cm to 5 cm, e.g., 1 cm-3 cm.

In certain embodiments, the face mask is made from a material having sufficient rigidity to maintain the dome-shaped structure. Thus, the face mask may include a rigid or a semi-rigid portion that provides the dome-shape. In certain embodiments, the face mask may be made from a transparent material. In certain embodiments, the periphery of the face mask may be configured to provide a seal against a person's skin. In certain embodiments, the periphery of the face mask may include a lining of a material that facilitates formation of the seal. Such materials can be soft materials that are adapted to form a seal with a person's skin and can include but are not limited to elastomeric materials, such as, silicone, latex, rubber, vinyl, polyurethane, etc. The thickness of the face mask can vary. In some examples, the face mask may have a thickness of 0.5 mm to about 0.2 mm.

The face mask also includes a septum that extends from an inside surface of the mask in an orientation that is substantially perpendicular to the inside surface of the mask. The septum may extend transversely from one side of the mask to the opposite side and divide the mask into a nose chamber and a mouth chamber. During use, the septum is substantially close to the wearer's skin and provides a separation between the air in the mouth chamber and the air in the nose chamber. The septum extends transversely across the face mask and includes an opening located substantially centrally in the septum. In other words, the septum is not present in the area of the mask positioned substantially under the nostrils of the wearer. The break in the septum allows for air exhaled from the nostrils to travel to the mouth chamber. In some embodiments, the opening in the septum may be closed by a unidirectional gate located in the opening, where the gate configured open downwards in response to exhalation from the nose of the user and to stay closed in absence of exhalation. Presence of the gate decreases inhalation of air from the mouth chamber of the user. In addition, when open, the gate closes upon increase in air pressure in the mouth chamber, thereby preventing air from the mouth chamber from travelling into the nose chamber. For example, the gate, if open, closes if the wearer coughs. In some embodiments, the gate may be a one-way valve flap, wherein one end of the flap is connected to a hinge that is constrained to keep the flap in a position substantially in line with the septum to effectively close the gap in the septum. The hinge may be configured to only allow the flap to move downwards upon application of pressure on the upper surface of the flap. The hinge is configured to resist movement of the flap to a position above closed position. Any suitable one-way valve or hinge may be used in the face masks described herein. In certain embodiments, the one-way valve may be the one-way valve described in U.S. Application Publication No. US20090133700, the disclosure of which is herein incorporated by reference. In some embodiments, the gate may be made from a fluid-impermeable material, i.e., a material that does not allow significant amount of air or moisture to pass therethrough. Such materials may include plastic, silicone, latex, rubber, and the like. The septum improves the quality of the air inhaled by the user by limiting the amount of air flowing into the nose chamber from the mouth chamber. In addition, the septum provides an enclosed nose chamber in the embodiments, where the face mask include only a nose mask and does not include a mouth chamber.

The face mask includes an inlet configured to allow passage of a tubing for placement of a proximal end of the tubing in the mask. In some embodiments, the inlet is a circular opening or a semi-circular opening in the face mask which inlet is located along a periphery of the face mask or in a portion of the dome shaped structure. In all embodiments, the inlet(s) may be located in the nose chamber. In some embodiments, the inlet is located adjacent the septum in an area immediately above the septum. In such embodiments, the septum can provide physical support to hold the tubing in place. In yet other examples, the septum may include a channel and the inlet may be located in an area of the face mask adjacent the septum and the tubing may be positioned in the septum via the inlet and may extend through the septum such that the proximal end of the tubing is located at the opening or at the location of the gate. In some embodiments, the face mask includes two inlets, a first inlet and a second inlet, where the first and second inlets are positioned substantially symmetrically on opposite ends of the nose chamber. The first and second inlets may be positioned adjacent the septum such that tubes positioned in the face mask via the inlets can be placed above the septum and may be in contact with the septum. The inlet(s) may include a lining of a compressible material to provide a tight fit with the tubing. In some examples, the compressible material may be silicone or rubber. The inlet(s) may include an attachment, such as an adaptor(s), that facilitate connecting the mask to the tubing from the air pump. In some embodiments, the tubing from the air pump may be permanently attached to an interior surface of the mask. In some instances, permanent attachment may be achieved by using an adhesive or heat to attach the proximal region of the tubing(s) to the interior of the mask. In yet another embodiment, the mask may include a two-layered configuration. For example, the mask may include two-layers in the nose chamber which two layers may be separable. In such embodiments, the tubing may be positioned in between the layers and may supply air between the two layers. The two layers may be attached to each other at the region of the mask adjacent the nostrils of a wearer. The attachment may be discontinuous, allowing the pumped air to pass through. The discontinuous attachment may include an attachment that includes a plurality of opening adjacent the nostrils of the wearer. In another example, an adapter may be attached to a periphery of the two layered mask. For example, an adapter may be attached to each side of the mask in the nose chamber such that the adaptors are placed closer to the ears of the wearer. When the adaptors are connected to tubings from the air pump, the pumped air travels from the adapter, between the two layers, and out close to the wearer's nostrils through a discontinuous seal between the two layers of the mask. In some instances, the two-layered structure may only be present in the area of the mask extending between the inlet (for passage of an adaptor or a tubing) and the area of the mask immediately adjacent the wearer's nostrils. In some instances, for example, in a nose mask, the entire mask may be a two-layered structure which allows air to fill between the two layers and exit close to the wearer's nostrils.

The face mask also includes removable and replaceable filters. The filters may be removed and tested for presence of matter trapped in the filters. The filters that are located in the face mask are referred to herein as face mask filters to distinguish these from filters from the filter present in the air pump described in the sections that follow. The face mask filter and air pump filter may be made from the same material or different materials. Any suitable filter may be used in the face masks and systems disclosed herein. These filters in general are configured for capturing microscopic particles and nanoparticles. For example, the filter may capture nanoparticles such as viruses. In some examples, the filter may be configured to allow nanoparticles to attach to the outermost surface of the filter. In other examples, the filter may be configured to allow nanoparticles to enter the filter via larger pores located on the outermost surface of the mask. The inner layers of the filter may include smaller pores that capture the nanoparticles. The filters may include a coating to increase capture of nanoparticles. The filters may be substantially flat. The filters may include multiple layers, such as, at least two, three, four or more layers, e.g., up to 10, 8, or 6 layers. The filters may be configured to capture viruses on both outermost layers or on only one outermost layer. In addition, the filter may prevent particles larger than 60 nm from passing through the filter. The filters can filter out microbes, viruses, smoke particles, and the like. In some embodiments, the filter may be made from a non-woven fiber material, e.g., from polypropylene (PP), rayon, polyethylene terephthalate (PET), or a combination thereof. In some embodiments, the filter may be a particulate filter that is electrostatically charged. In some embodiments, the filter may be a particulate filter that comprises activated charcoal.

In some embodiments, the face mask includes the gate and the filter is positioned on the gate. In some embodiments, the filter is positioned on the upper surface of the gate. In some embodiments, the filter is positioned adjacent the mouth of the user. In some embodiments, the filter is positioned adjacent the mouth of the user and on the gate. The adjacent position may be a position in the face mask immediately opposite the wearer's mouth. The adjacent position may be a position in the face mask below the mouth, e.g., in the area of the mask under the chin of the wearer. In certain embodiments, the mask is made from a substantially fluid-impermeable material and forms a seal against a wearer's skin and includes a filter positioned adjacent the wearer's mouth to vent the air from the mouth chamber to outside the mask.

The size and shape of the facemask is adapted to fit over at least the nose and mouth of a person to define an interior air space when worn. The face mask may have a vertical length and a transverse length. As used herein, the vertical length refers to the length along the vertical axis of symmetry between the top end of the face mask and the bottom end of the face mask, where the top end is meant for positioning on the nose and the bottom end is meant for positioning under the of the user. The vertical length is longer for the face mask described herein and shorter for the nose mask described herein.

In some embodiments, the nose masks may be a version of the facemask where the mouth chamber is not included and the septum encloses the bottom area of the nose mask. In some embodiments, the nose masks may be a version of the facemask where the mouth chamber is not included, and the septum is not included. Such nose masks are designed for use with a disposable or reusable cloth mask or mask made from other flexible materials.

The face masks, including the nose masks, described herein are configured for use in a system that includes an air pump and tube(s) for supplying air from the air pump to the face mask. Thus, the systems include a face mask, tube(s), and an air pump.

### Systems

As previously noted, a system comprising the face-mask disclosed herein, a tubing, and an air pump, where the air pump is configured to draw in ambient air and provide filtered air, where the pump is connected to a distal end of the tubing and is configured to provide positive air flow into the face mask via a proximal end of the tubing such that the face mask has a net positive air flow comprising a net movement of air out of the face mask is provided. The use of the air pump provides at least two main advantageous features to the disclosed systems. The air pump maintains a unidirectional flow of air, where the air flows from the nose chamber to the mouth chamber and out of the filter located in the mouth chamber. In some embodiments, the air from the mouth chamber may also flow out from an area between the periphery of the face mask and the skin of the wearer. In some embodiments, the air from the nose chamber may flow out from an area between the periphery of the face mask and the skin of the wearer. The use of the air pump enables maintenance of a unidirectional air flow from inside to outside of the mask which improves the quality of air inside the mask and also reduces flow of air from the edges of the mask where the seal between the mask and the wearer's face is leaky. The air pump also includes a filter that removes microscopic particles and nanoparticles from the ambient air before pumping it into the face mask. As described in the preceding section, the air pump filter may be any suitable filter, such as, a commercially available filter. The air pump filter may be removable and replaceable. The replaced filter may be analyzed for presence of microscopic particles and/or nanoparticles captured in the filter.

The air pump may be a commercially available pump or a custom-made pump. The air pump may have at least three different settings for regulating the amount of air pumped. In some examples, the air pump may have means for regulating speed of air flow into the tubing. In some examples, the means may be the amount of energy provided to the motor of the air pump. The means may be controllable by the user. The means may be controllable by a user by toggling a dial or depressing a button. For example, the wearer may use the lowest speed setting when sedentary, a higher speed when engaged in light physical activity and the highest speed when engaged in intense physical activity. In some examples, the means may be automatic and may be responsive to change in air pressure in ambient air and/or change in air pressure in the tubing. In certain examples, the air pump may include a microchip that controls speed of the motor of the air pump in response to detected back air flow or drop in ambient air pressure. The air pump may be powered by a battery that may be rechargeable. In some embodiments, the air pump includes a housing comprising the filter, motor, fan, and the battery. In other embodiments, the battery may be placed outside of the housing and connected to the motor via external wires. An externally placed battery may decrease the overall weight of the air pump.

In some embodiments, the filter present in the pump and/or the filter present in the face mask may carry a unique identifier. The unique identifier may be a series of numbers, a bar code, a QR code providing a link to a database containing information regarding identification number for the filter. The unique identifier provides the capability to link the filter to a particular mask, air pump, and/or a user. The unique identifier may be used to track the filter when the filter is sent for analysis to determine presence of a microbe or virus or another noxious agent in the filter.

The presently disclosed systems may include a tubing comprising a distal end that can be connected to the air pump and a proximal end that can be placed in the face mask. In some embodiments, the presently disclosed systems may include a tubing comprising a distal portion and a proximal portion, the distal portion comprising an undivided tube portion having a first lumen therein; the proximal portion comprising a divided tube portion comprising two tubes each having second lumens therein, wherein the first lumen is continuous with the second lumens and where the width of the two lumens is approximately half of the first lumen. The distal portion comprises the distal end connected to the air pump, and the two tubes in the proximal portion each comprise the proximal end connected to the face mask. As used herein, distal and proximal are relative terms, where the term proximal is used to refer to the part of the tubing closer to the face of a wearer and the term distal is used to refer to the part of the tubing closer to pump. The terms tube, tubing, and hose are used interchangeably and do not imply any particular dimension, shape, or appearance. The tubing may have any suitable shape. The shape of the tubing in the proximal and distal portions may be same or different. In one embodiment, the undivided tube portion having a first lumen therein may be approximately cylindrical in shape and has a circular cross-section while the divided tube portion comprising two tubes each having second lumens therein may be hemi-cylindrical in shape and second lumens may have a semicircular cross-section.

The overall length of the tubing may be varied and selected based on the desired placement of the pump with reference to the face of a wearer. The length of the proximal portion comprising the divided tube portion may be chosen in some embodiments to fit snugly to the back of the head or back of the neck of the wearer. The divided tube portion may include an attachment positioned around the distal undivided portion and that can be moved to collect the divided tubes and slid up the divided tubes to effectively decrease the length of the divided portion with reference to the back of the head or neck of the wearer. In some embodiments, the attachment may be a sliding attachment that can be slid closer or farther from the back of the head or neck of the wearer to increase or decrease the snugness of the fit. The sliding attachment may be a clip, cinch, or a Velcro band. In other instances, the attachment may be a separate feature that can be attached to the desired location on the divided regions to the tube, e.g., a Velcro band.

The tube(s) may be made of any lightweight material that is impermeable to fluids. The material may be anti-microbial. The tube(s) may include an anti-microbial coating on an internal surface. The tube(s) may be made from a semi-transparent or substantially transparent material. The tube(s) may have a semi-rigid or flexible configuration. The tube(s) may be made from a crush-resistant material. In some embodiments, the tube(s) may be flexible and may be configured to accommodate stretching of the tube, such as, from occasional pulling on the tube. Such a stretchable configuration can involve a wall that is corrugated and adopts a slightly coiled appearance where the wall has rings and grooves. Upon application of a pulling force, the rings and grooves may separate to increase the length of the tube. Medical hoses such as those provided with CPAP machines, nebulizers, etc., may be used as the tubing in the presently disclosed system.

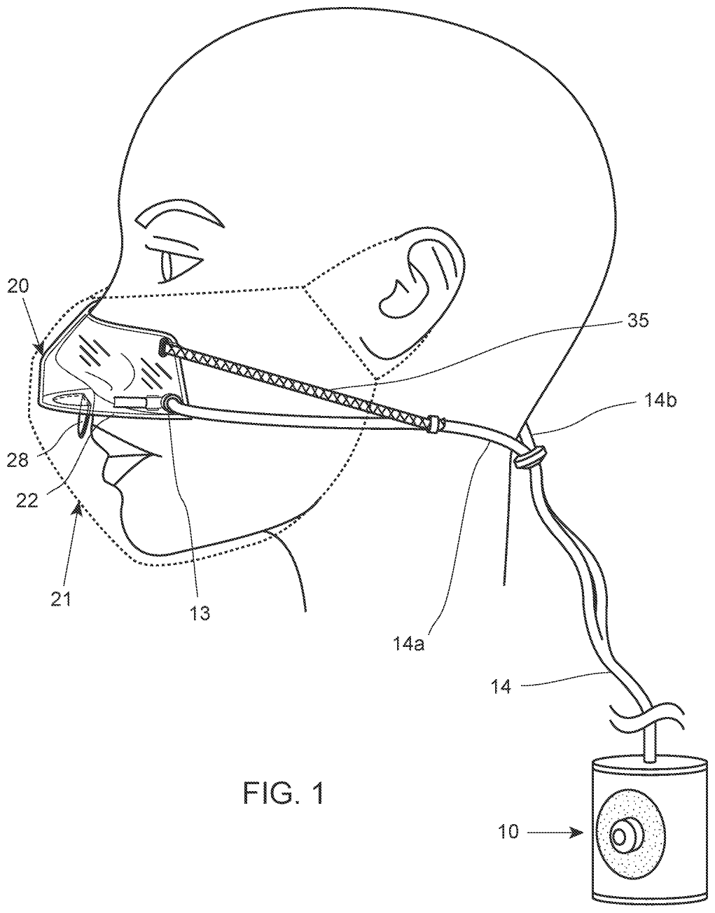

Specific embodiments of the face masks and systems disclosed herein are illustrated in FIGS. 1-5.

FIG. 1 shows a schematic of a system of the present disclosure. The system includes an air pump 10 that includes a filter for purifying air by removing microparticles and nanoparticles from the air prior to pumping the air into the mask. The filter can be easily accessed by removing an outer cover of the pump. A hose 14 connects the pump to the face mask 20. The hose includes a distal portion that is a single tube and a proximal portion that includes two tubes 14a and 14b formed by dividing the single tube. The nose mask 20 includes an inlet 13 through which the tube 14a enters the face mask. The nose mask includes a septum 22 that extends from the inner surface of the mask towards the wearer's face. Also depicted is an unidirectional flap valve 28. The upper surface of the flap valve 28 may be covered with a removable filter. An elastic strap 35 may be attached to the top part of the nose mask and may be used to immobilize the mask on a wearer's face. The proximal end of the divided tubing 14a may be positioned approximately at the mid-point between the flap and the inlet or closer to the nose of the wearer. While the flap is depicted as being attached to a region of the septum distal from the inner surface of the mask, other regions of the septum may be used for attaching the flap. For example, the flap may be attached to a region of the septum proximal to the inner surface of the mask. In some instances, the nose mask may be used in conjunction with a standard face mask, e.g., a reusable cloth mask or a disposable mask. The standard face mask 21 may be pulled over the mouth or may be pulled over the nose and mouth of the wearer over the nose mask, as depicted in FIG. 1.

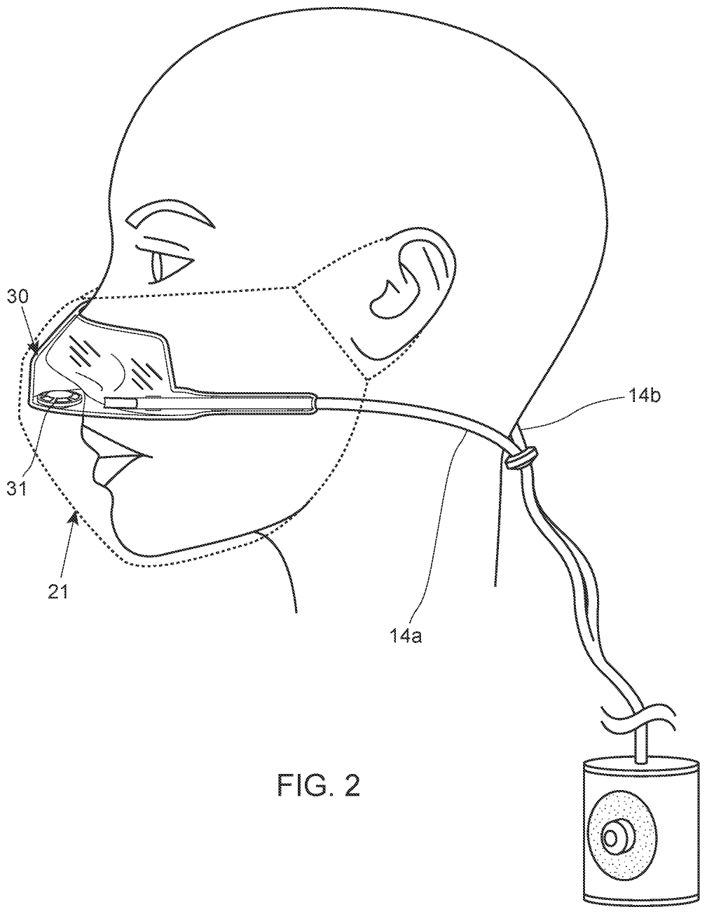

FIG. 2 depicts a variation of a nose mask according to an embodiment disclosed herein. This nose mask 30 includes a one-way valve 31 that swings downwards upon exhalation by the wearer. This nose mask may not include an elastic band and instead may have an extended side region for adhering to a wearer's skin. The extended side region also provides surface to support the tubings 14a and 14b.

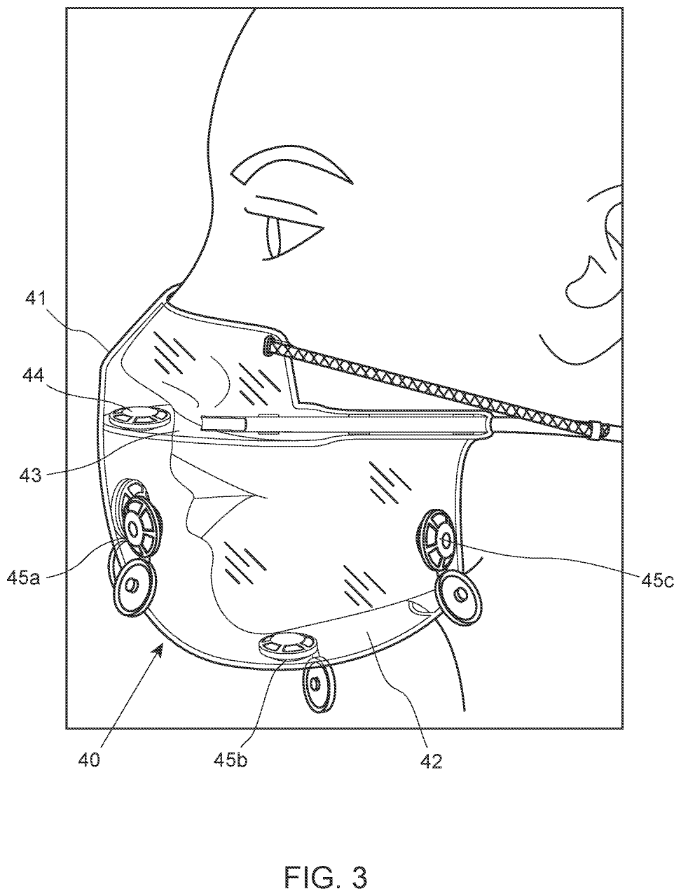

FIG. 3 shows a face mask 40 that includes a nose chamber 41 and a mouth chamber 42 created by the septum 43. A one-way valve 44 is also depicted. Additional vents 45a, 45b, and 45c are located in the mouth chamber with vent 45a located adjacent the wearer's mouth, vent 45b located adjacent the wearer's chin, and vent 45c located towards the back of the wearer's jawline. The vents may be placed symmetrically on both sides of the mouth chamber. Unlike the one-way valve 44, the vents may stay open during use. The vents include a filter that captures microscopic and nanoparticles being released by the wearer. In addition, since the air flow is unidirectional and the air flows out of the vents, the captured particles are substantially those released from the wearer's airways. These filters may be analyzed to determine whether the wearer has an infection, e.g., a viral or a microbial infection.

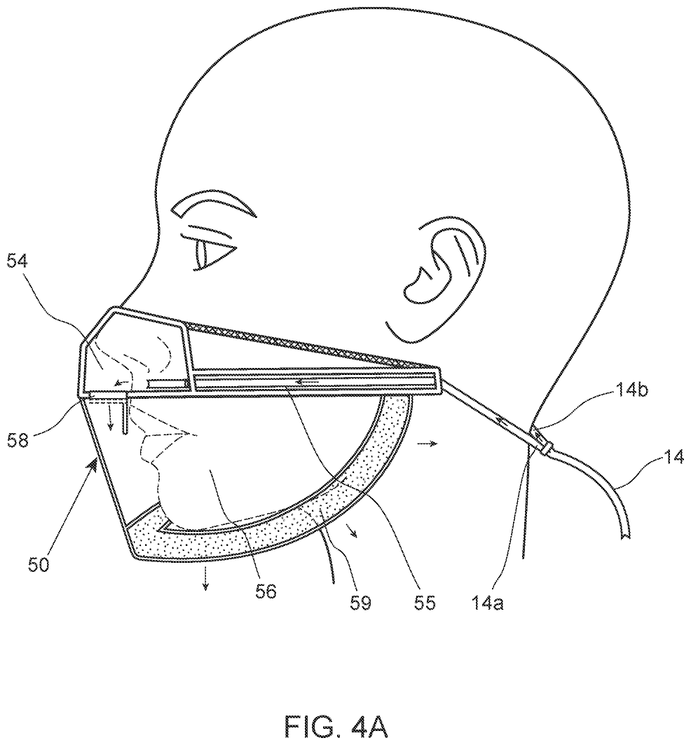

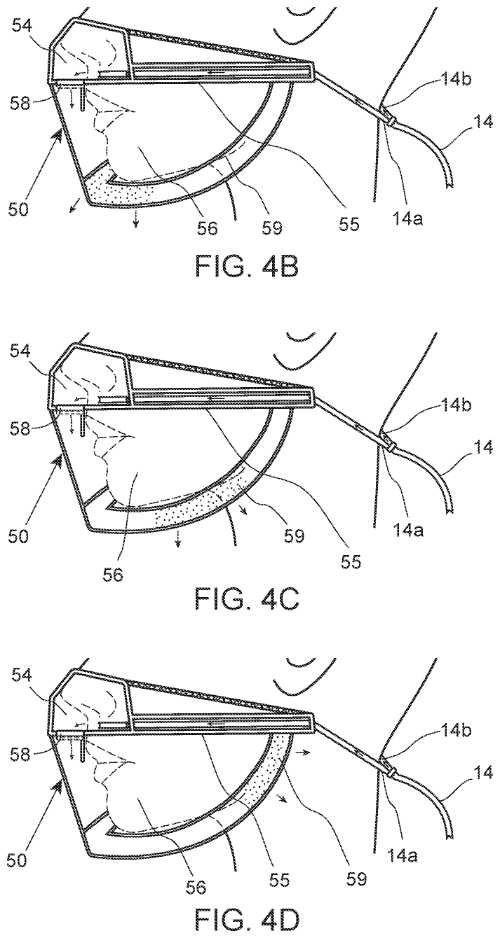

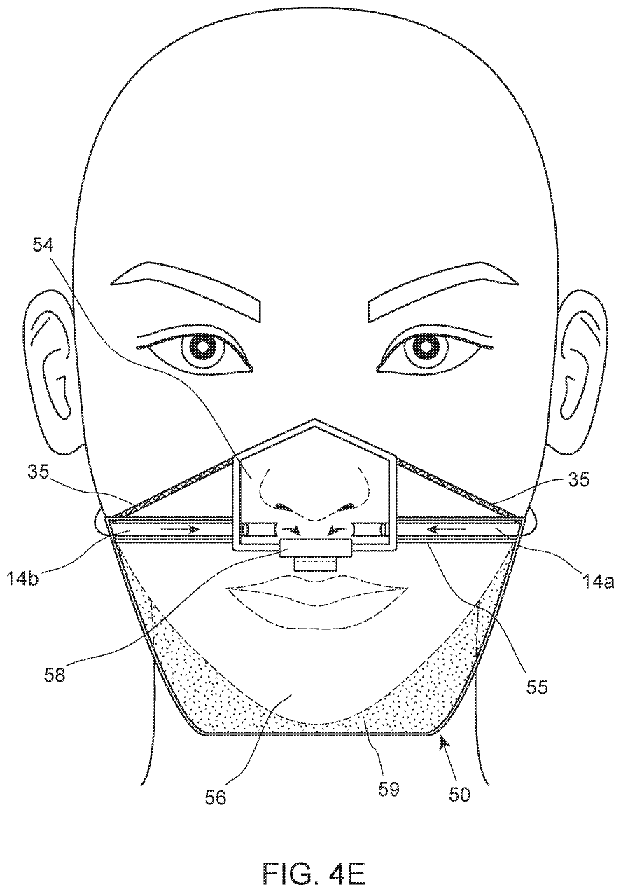

FIGS. 4A-4E depict different embodiments of a face mask disclosed herein. The facemask 50 is divided into a nose chamber 54 and a mouth chamber 56 via septum 55. In FIG. 4A, the filter 59 extends in a majority of the lower region of the mouth chamber to facilitate removal of exhaled air. Also shown in the figures is an unidirectional flap valve 58. The valve 58 may also include a filter attached to the upper surface of the valve. In FIG. 4B, the filter is only positioned in a region adjacent the mouth of the wearer. In this configuration, the exhaled air flows substantially out of the front of the mask. In FIG. 4C, the filter is only positioned in a region below the chin of the wearer. In this configuration, the exhaled air flows substantially out of the bottom region of the mask. In FIG. 4D, the filter is only positioned in a region towards the end of the wearer's jaw and the exhaled air flows substantially out of the back of the mask. FIG. 4E provides a frontal view of the face mask shown in FIG. 4A. The two tubes 14a and 14b are depicted with the proximal openings positioned adjacent the wearer's nostrils. The septum 52 and the unidirectional flap valve 58 dividing the face mask into the nose chamber 24 and mouth chamber 26 are also depicted. The lower part of the mouth chamber includes the filter 59. An elastic strap 35 attached to both sides of the nose chamber is also illustrated.

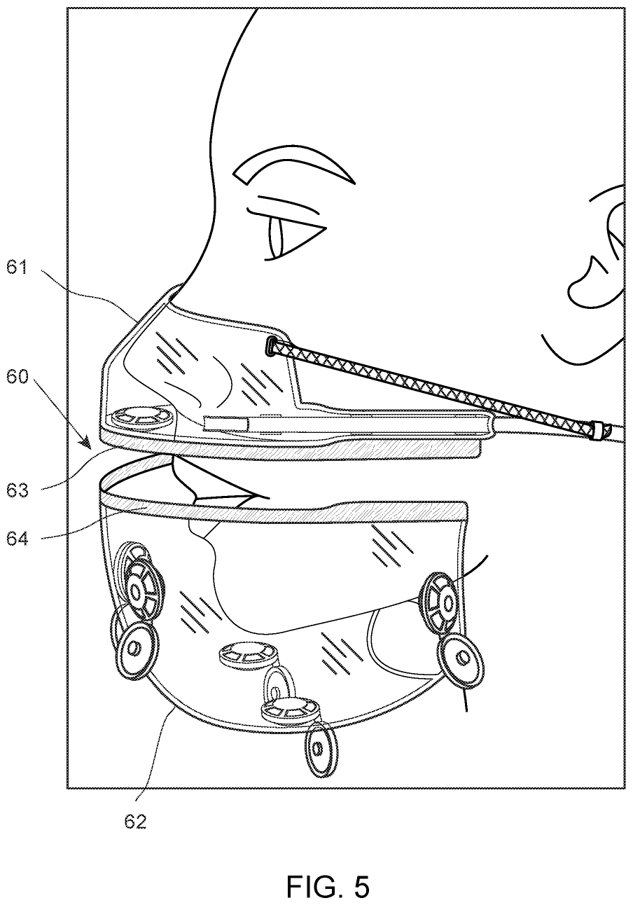

FIG. 5 shows a face mask 60 with a detachable mouth chamber 62. The bottom periphery of the nose chamber includes a means 63 and the top periphery of the mouth chamber includes a means 64 for attaching the nose and mouth chambers. Means can include Velcro or another adhesive or snap-in features for attaching the nose and mouth chambers.

In some embodiments, the lower part of the face mask may include a frame that mates with a removable filter cartridge. The removable filter cartridge may snap into the frame, in some embodiments. The removable filter cartridge may include a frame to which a filter is attached, and the frame may be snapped into the frame in the mouth chamber.

In some embodiments, the face mask may include a material configured for sound transmission. In some embodiments, the face mask may include ear loops for holding the face mask against a wearer's face. In some embodiments, the face mask may include head strap(s) that go around a wearer's head to hold the face mask against a wearer's face. The ear loops and the head straps may be elastic. The face masks disclosed herein only cover the nose (usually the lower half of the nose) and the mouth and chin of the wearer. The nose masks herein only cover the nose (usually the lower half of the nose) of the wearer. Other parts of the face, such as, the upper half of the face, e.g., eyes are not covered.

In some embodiments, the tubes and/or pump may have attachment means for attaching the tube and/or pump to a wearer. For example, the pump may include a belt clip or a Velcro strap for attaching the pump to the wearer's arm. The pump may be relatively small in size. For example, the net weight of the pump may be less than 500 grams, e.g., less than 100 grams. The length of the tubing measured from the proximal to the distal end may not exceed 100 cm in some embodiments. In any of the embodiments disclosed herein the length of the tubing measured from the proximal to the distal end may be about 30 cm-100 cm, e.g., 30 cm-50 cm, 50 cm-70 cm, or 70 cm-100 cm.

### Auxiliary Kits

Provided herein are tubings that can be attached to a face mask, such as, a standard face mask made from a soft fabric-like material. Standard face masks include reusable cloth masks, disposable face masks made from non-woven fabric, polypropylene and the like. The tubings and air pumps can be used for supplying filtered air to a wearer wearing a standard face mask. The distal end of the tubing is connectable to an air pump comprising a filter for filtering microscopic and nanoparticles from the air, where the air pump transports the filtered air to a proximal end of the tubing. The proximal region of the tubing may include means for attaching the proximal region of the tubing to a face mask, where the proximal end of the tubing is insertable via an opening approximately centrally located in the face mask. The means may include Velcro attachment, clip, snap-in grommet, or a combination thereof.

In certain instances, the means is a snap-in fabric grommet. In certain instances, the proximal end of the tubing comprises a pointed-end that facilitates piercing the face mask to create the opening in the face mask. The pointed-end may be configured as a snap-off feature which in use is snapped off and removed to create a new proximal end of the tubing.

In certain instances, a first piece of a two-piece grommet may be positioned near the proximal end of the tubing and the second piece of the grommet is included with the tubing, wherein after the proximal end of the tubing is inserted into the opening of the facemask, the second piece of the grommet is slid onto the proximal end from the side of the face mask facing the wearer and snapped with the first piece positioned immediately adjacent the opposite side of the face mask.

In certain instances, the proximal end of the tubing is bifurcated or multi-furcated into mini tubules, or expands into substantially circular shape comprising a planar end positionable adjacent a wearer's nose, wherein the planar end comprises a plurality of openings, wherein the proximal end distributes the filtered air substantially evenly across the wearer's nose.

In certain instances, the tubing comprises in one or more regions between the proximal and distal ends means for attaching the one or more regions to the wearer's clothing or glasses, wherein the means comprises Velcro or a clip.

In certain instances, the tubing comprises a flexible, slip resistant material for securing the tubing over and behind the ear of the wearer. The tubing may also include a light-weight support wire running along the tubing to provide support and bendability to the tubing to facilitate manipulating the tubing into various positions. Examples of flexible tubing material includes silicone, polypropylene, etc. Examples of light-weight support wire includes aluminum, copper, nickel, nitinol, etc.

In certain instances, the proximal region of the tubing includes an elbow shape leading into the proximal end. For example, a 90-degree bend in the region adjacent the proximal end.

The auxiliary kit may include a tubing and an air pump. The auxiliary kit may additionally include disposable or reusable masks. If reusable or disposable masks are included, they may be attached to the tubing and an air pump. The air pump may be as described in the previous sections.

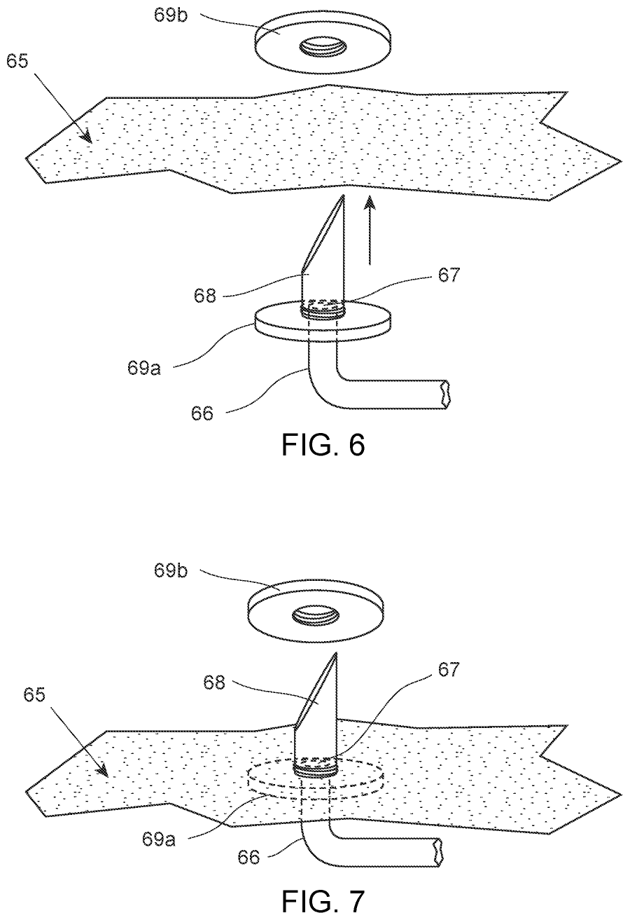

Certain examples showing the tubings that may be supplied as an auxiliary for use with a face mask and an air pump are depicted in FIGS. 6-15.

FIG. 6 depicts a part of a face mask 65 and a proximal region of a tubing 66. The proximal region includes adjacent the proximal end 67 a pointed-end 68 configured to facilitate piercing of the face mask. The pointed-end 68 is configured to enable snapping off of the pointed end after the proximal end of the tubing has been inserted in the face mask. A first piece 69a of a two piece of grommet is supplied with the tubing and is attached to the tubing at an area off-set from the proximal end of the tubing. The tubing in the proximal region includes an elbow shape, e.g., a 90° bend in the tubing as shown.

FIG. 7 depicts insertion of the pointed-end through the face masks such that the proximal region is located on the side of the face mask facing the wearer's face.

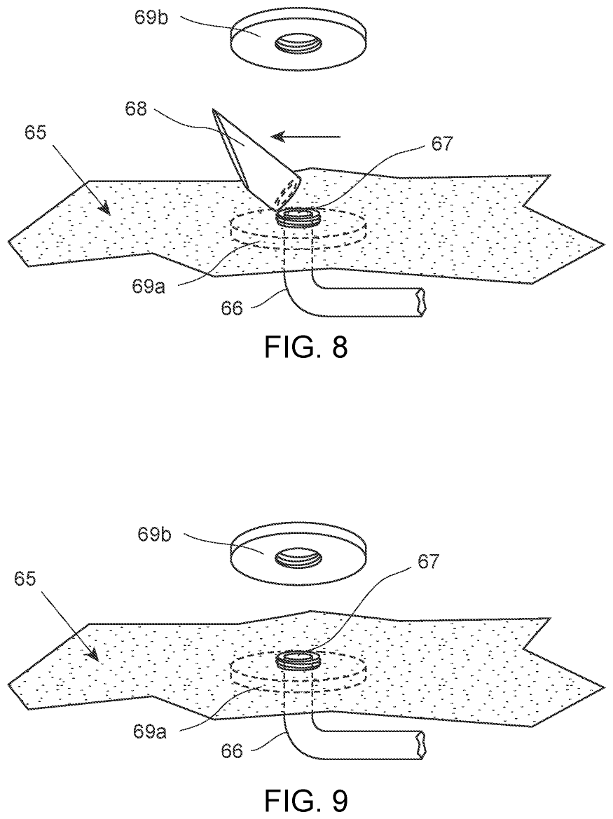

FIGS. 8 and 9 depict snapping off of the pointed-end and the attachment of the second piece of the grommet. The user can hold the tubing in place at the opening created by the pointed end, while bringing in the second piece of the grommet to slide onto the proximal end of the tubing. The pointed end may be configured with perforations to facilitate snapping-off of the pointed-end.

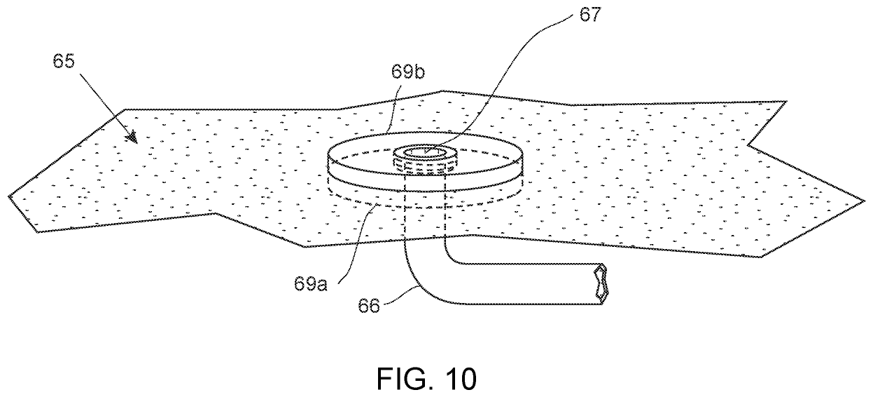

FIG. 10 illustrates the proximal tubing immobilized in the opening in the face mask.

The pointed-end may be snapped-off before or after the second piece of the grommet is snapped onto the first piece. In some instances, the proximal end of the tube may be inserted further into the mask.

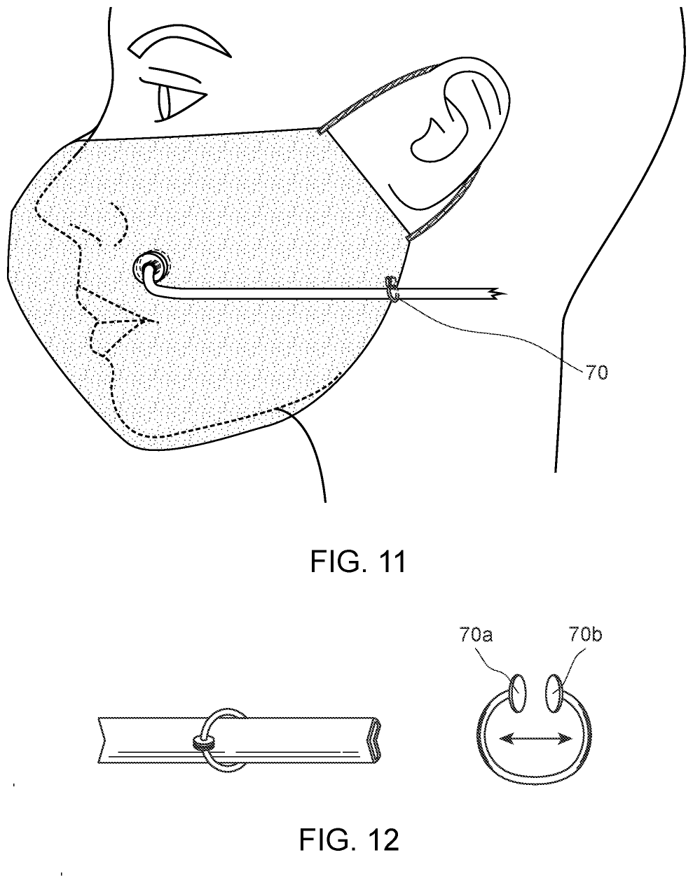

FIG. 11 depicts the face mask that has been fitted with a tubing using a snap-in grommet. In addition, a clip 70 can be used to attach the tubing to any location of choice along the mask. Alternatively, the clip can be used to attach the tubing to a wearer's clothing.

FIG. 12 shows a closer view of the clip. The clip may be made of a pliable material such as a soft metal that can be pressed together. Alternatively, the clip may include magnets at the ends that clip together.

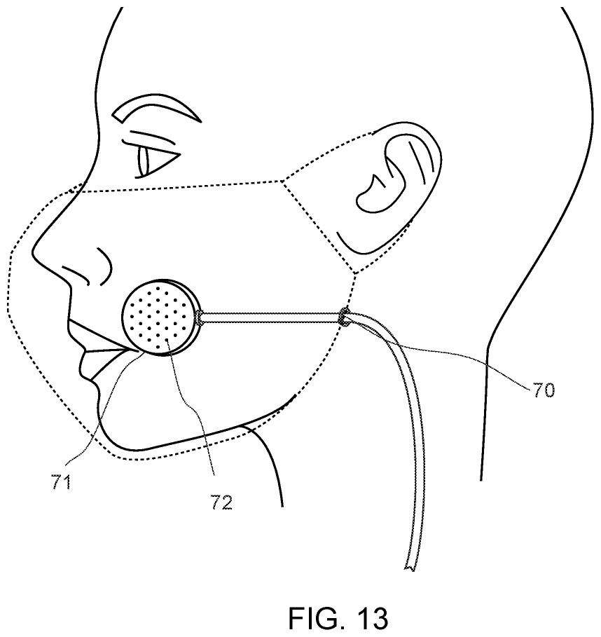

FIG. 13 shows another embodiment of a tubing disclosed herein. The proximal end of the tubing extends into a rounded region, such as, a disc 71 with a plurality of holes 72 for exit of filtered air. The holes are present in the regions facing the wearer and optionally on the opposite side of the disc. A clip used for holding the tubing in position is also depicted. During use, the disc and the proximal region of the tubing may be placed on the inside surface of the mask and immobilized via the clip 70.

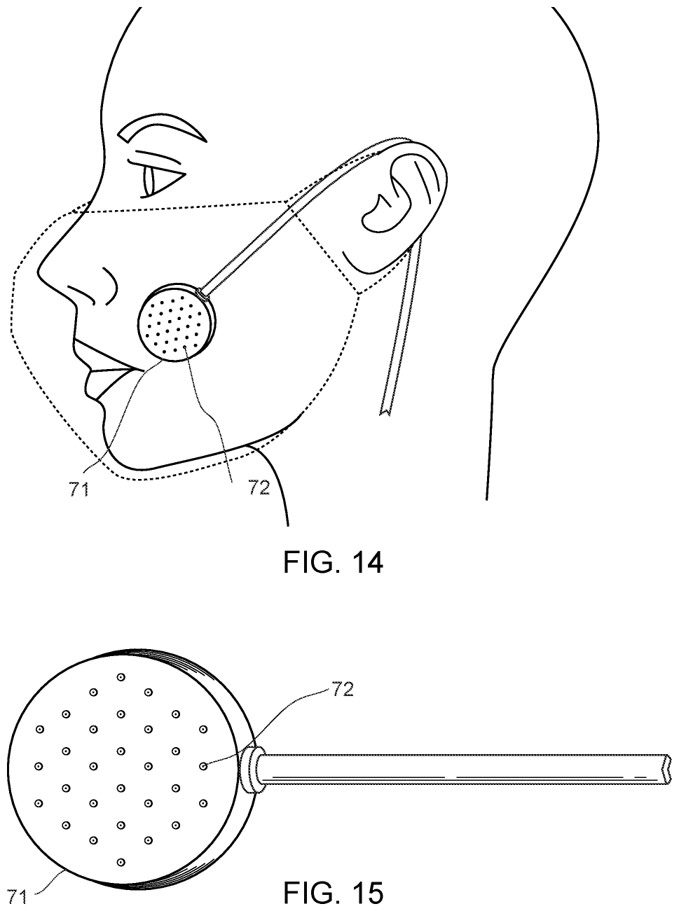

FIG. 14 shows the tubing as in FIG. 13 placed inside the face mask and held in place by a combination of support provided by the face mask and the wearer's ear.

FIG. 15 shows a close-up of the proximal end of the tubing showing the disc shaped feature for distributing the air in the face mask.

### Methods

The systems disclosed herein may be used to protect the wearer from noxious agents present in the environment. Such noxious agents can include microbes, viruses, dust, ash, smoke, etc.

The systems include at least two filters. The filter located in the air pump is an intake filter which can capture microbes and viruses present in a person's environment. Analysis of the filter can reveal if the person has visited a location where the microbes/virus is present. The filter located in the mouth chamber of face mask is a venting filter where the air exits the mouth chamber. The face mask filter can be analyzed to reveal if the wearer has an infection with a microbe or virus.

Accordingly, a method of detecting presence of a virus or a microbe in a person is provided, where the person is using the above-described system. The method may include obtaining the filter from the face mask; analyzing the filter for presence of the virus or microbe, wherein presence of a virus or a microbe in the filter is indicative of presence of the virus or microbe in the person. The method may further include a step of recording the results of the analyzing and the unique identifier for the filter. The method may further include tagging the results of the analyzing with information regarding locations visited by the person. The locations visited by the person may be obtained by questioning the person or preferably by analyzing the geolocation information of a person's mobile phone.

A method for detecting presence of a virus or a microbe in a person's environment is disclosed, where the person is using the above-described system. The method may include obtaining the pump filter from the pump; analyzing the pump filter for presence of the virus or microbe, where presence of the virus or microbe in the filter indicates the presence of a virus or a microbe in the person's environment. The method may further include a step of recording results of the analyzing and the unique identifier for the pump filter. The method may further include tagging the results of the analyzing with information regarding locations visited by the person.

A method for simultaneously detecting presence of a virus or microbe in a person's environment and in the person is also provided, where the person is using the above-described system. The method may include obtaining the pump filter from the pump; analyzing the pump filter for presence of the virus or microbe; obtaining the filter from the face mask; and analyzing the filter for presence of the virus or microbe, where presence of virus or microbe in the pump filter is indicative of presence of a virus or microbe in the person's environment, and where presence of virus or microbe in the filter from the face mask is indicative of presence of a virus or microbe in the person.

While the present invention has been described with reference to the specific embodiments thereof, it should be understood by those skilled in the art that various changes may be made, and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

1. A face mask, comprising:
a dome-shaped structure sized to cover a human user's nose and mouth, wherein the structure comprises an inlet sized to allow passage of a tubing;
a septum located inside the structure, separating the inside of the structure into a nose chamber and mouth chamber,
the septum comprising an opening located substantially centrally in the septum, the opening optionally comprising a gate configured open downwards in response to exhalation from the nose of the user and to stay closed in absence of exhalation;
and
a filter located in the structure in an area adjacent to the mouth of the user and/or a filter located in the gate, when present,
wherein the filter is configured for capturing microscopic particles and nanoparticles.

2. The face mask according to claim 1, wherein the inlet comprises a circular opening or a semi-circular opening in the structure.

3. The face mask according to claim 1, wherein the inlet comprises a semi-circular indentation in a perimeter of the structure.

4. The face mask according to claim 1, wherein the inlet comprises a border comprising a compressible material defining a diameter smaller than the diameter of the tubing.

5. The face mask according to claim 1, comprising a first inlet and a second inlet, wherein the first and second inlets are positioned substantially symmetrically on opposite ends of the nose chamber and wherein the first and second inlets are positioned adjacent the septum.

6. The face mask according to claim 5, wherein the first inlet and the second inlet each comprises a circular opening or a semi-circular opening in the structure.

7. The face mask according to claim 5, wherein the first inlet and the second inlet each comprises a semi-circular indentation in a perimeter of the structure.

8. The face mask according to claim 5, wherein the first inlet and the second inlet each comprises a border comprising a compressible material defining a diameter smaller than the diameter of the tubing.

9. The face mask according to claim 1, wherein the filter is located in the structure in an area adjacent to the mouth of the user.

10. The face mask according to claim 1, wherein the opening comprises a gate configured to move downwards in response to exhalation from the nose of the user.

11. The face mask according to claim 10, wherein the gate comprises a one-way valve.

12. The face mask according to claim 1, wherein the gate comprises the filter, optionally, wherein the filter is removable and replaceable.

13. A system comprising the face-mask according to claim 1, a tubing, and an air pump, wherein the air pump is configured to draw in ambient air and provide filtered air, wherein the pump is connected to a distal end of the tubing and is configured to provide positive air flow into the face mask via a proximal end of the tubing such that the face mask has a net positive air flow comprising a net movement of air out of the face mask.

14. The system according to claim 13, wherein the net movement of air out of the face mask occurs through the filter located in the structure in an area adjacent to the mouth of the user.

15-18. (canceled)

19. The system according to claim 13, wherein the pump comprises a pump filter configured for capturing microscopic particles and nanoparticles, wherein the pump filter comprises a unique identifier, and wherein the pump filter is removable and replaceable.

20-23. (canceled)

24. The face mask according to claim 1, wherein the face mask comprises a substantially clear material and/or a material configured for sound transmission.

25. (canceled)

26. A method of detecting presence of a virus or a microbe in a person, wherein the person is using a face mask according to claim 1, the method comprising:
obtaining the filter from the face mask;
analyzing the filter for presence of the virus or microbe,
wherein presence of a virus or a microbe in the filter is indicative of presence of the virus or microbe in the person.

27-28. (canceled)

29. A method for detecting presence of a virus or a microbe in a person's environment, wherein the person is using a system according to claim 13, the method comprising:
obtaining the pump filter from the pump;
analyzing the pump filter for presence of the virus or microbe,
wherein presence of the virus or microbe in the filter indicates the presence of a virus or a microbe in the person's environment.

30-31. (canceled)

32. A method for simultaneously detecting presence of a virus or microbe in a person's environment and in the person, wherein the person is using a system according to claim 13, the method comprising:
obtaining the pump filter from the pump;
analyzing the pump filter for presence of the virus or microbe;
obtaining the filter from the face mask; and
analyzing the filter for presence of the virus or microbe,
wherein presence of virus or microbe in the pump filter is indicative of presence of a virus or microbe in the person's environment, and
wherein presence of virus or microbe in the filter from the face mask is indicative of presence of a virus or microbe in the person.

33. A nose-mask comprising:
a dome-shaped structure sized to cover a human user's nose,
wherein the mask extends to an area under the human user's nose and comprises an opening under the nostril area or comprises a gate configured to open downwards in response to exhalation and to stay closed in absence of exhalation; and
a first inlet and a second inlet sized to allow passage of a tubing, wherein the inlets are located in an area adjacent the center of the mask under the nostril and are placed on opposite sides of the mask,
wherein the mask does not extend to cover the mouth of the user.

34-50. (canceled)
